(19) United States
(12) Patent Application Publication
(10) Pub. No.: US 2013/0138768 A1
(43) Pub. Date: May 30, 2013

(54) Method and System for Dynamic Service Creation on Sensor Gateways

(71) Applicant: Vincent Huang, (US)

(72) Inventor: Vincent Huang, (US)

(21) Appl. No.: 13/308,230

(22) Filed: Nov. 30, 2011

(51) Int. Cl. G06F 15/16

(52) U.S. Cl. 709/217

(57) ABSTRACT

A user equipment (UE) includes a user interface for user input of a request for execution of a service, a transceiver for communicating with a plurality of network locations, a memory and a processor. The processor instructs the transceiver to transmit the user requested service to a network location and receive a description of the service including gateway capabilities needed for performing the service from the network location, transmit the service description to a directory and receive an identity of a gateway having the required capabilities from the directory, transmit the service request to the at least one identified gateway and receive results of the service request from the gateway. The memory stores the: description received from the network location, identity of a gateway received from the directory and results received from the gateway.

### TECHNICAL FIELD

The invention is related to sensor networks and more particularly to optimizing functionality of these sensors.

### BACKGROUND

The deployment and use of sensors and sensor networks is currently growing at an exponential rate. As a result, sensors have become ubiquitous. Sensors are connected to smart phones, cars, buildings and public spaces including cell towers. It is projected that by 2020, upwards of fifty billion connected devices may be in use throughout the world.

The sensors are normally small in size and have limited computational capacity. They are connected to a network through gateways. The functionality and/or services provided by these sensors are deployed on the gateways. The gateways register the capabilities (i.e. functionality and/or services) of the sensors (connected to the gateways) on a directory in order for them to be discovered and accessed. A service from a gateway may be invoked or requested by an application on a user equipment or communication device.

Currently, all services provided by the sensors have to be deployed on gateways and registered on a directory or directories. The current sensor gateways typically have fixed functionality at development time. Such implementation slows down the deployment of new services using sensors.

What is desired is a mechanism for dynamically deploying new services on the gateways utilizing a prior knowledge of the capability of the gateways. It is also desirable to find a gateway having the capability to provide a certain service.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with an exemplary embodiment, a system for providing a service to a user of a communication device is disclosed. The system comprises: a server at a network location having a plurality of service descriptions stored therein; a plurality of gateways on the network each having at least one of a sensor and an actuator; and a directory on the network and connected to the gateways and including information about each of the gateways wherein the communication device specifies a service and a description for the specified service is retrieved from the server and provided to the directory for identifying a gateway for performing the service.

In accordance with another exemplary embodiment, a method of obtaining a service from one of a plurality of gateways is disclosed. The method comprises the steps of: obtaining a description for the service including gateway capabilities needed for performing the service; identifying at least one gateway having the required capabilities from a directory; submitting the service request to the at least one identified gateway; and receiving results of the service request from the gateway. Each gateway may be associated with at least one of a sensor and an actuator.

In accordance with a further exemplary embodiment, a user equipment is disclosed. The user equipment comprises: a user interface for user input of a request for execution of a service; a transceiver for communicating with a plurality of network locations; a processor and a memory. The processor instructs the transceiver to: transmit the user requested service to a network location and receive a description of the service including gateway capabilities needed for performing the service from the network location, transmit the service description to a directory and receive an identity of a gateway having the required capabilities from the directory, and transmit the service request to the at least one identified gateway and receive results of the service request from the gateway. The memory stores: an identity of the user requested service, the description received from the network location, the identity of a gateway received from the directory, and the results received from the gateway.

In accordance with yet another embodiment, a computer program for obtaining a service from one of a plurality of gateways is disclosed. The program comprises computer readable program modules which, when run on a user equipment, causes the user equipment to: obtain a description for the service including gateway capabilities needed for performing the service; identify at least one gateway having the required capabilities from a directory; submit the service request to the at least one identified gateway; and receive results of the service request from the gateway wherein each gateway is associated with at least one of a sensor and an actuator.

### BRIEF DESCRIPTION OF THE DRAWINGS

The objects and advantages of the invention will be understood by reading the following detailed description in conjunction with the drawings in which:

FIG. 1 illustrates a system in accordance with exemplary embodiments;

FIG. 2 illustrates a method in accordance with exemplary embodiments;

FIG. 3 illustrates a user equipment in accordance with exemplary embodiments; and

FIG. 4 illustrates a gateway in accordance with exemplary embodiments.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors).

Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

In exemplary embodiments, methods, apparatus and systems are disclosed for dynamically deploying services on a gateway. Exemplary embodiments provide an application seeking service from a gateway with prior knowledge of the gateway's capabilities.

Exemplary embodiments are directed to facilitating dynamic service deployment in sensor gateways. In order to efficiently utilize the capacity of a gateway, exemplary embodiments describe a system for dynamically deploying services on a sensor gateway according to user needs. The user discovers a gateway from a directory and sends requests with link to desired services to the gateway as described in further detail below.

A gateway may update the directory of changes in its (i.e. gateway's) capabilities such as changes in connected sensors and actuators (i.e. hardware changes). The gateways may not have fixed services. The services may be deployed dynamically at run time based on the request from an application.

Exemplary embodiments may provide for a separation between the hardware needed for delivering a service from the software used to create a service. An application can request a service with a representational state transfer (REST) style service request which may include the unified resource identifier (URI) for the service to be performed. A gateway lacking previous knowledge about the service can dynamically create customized services for each request.

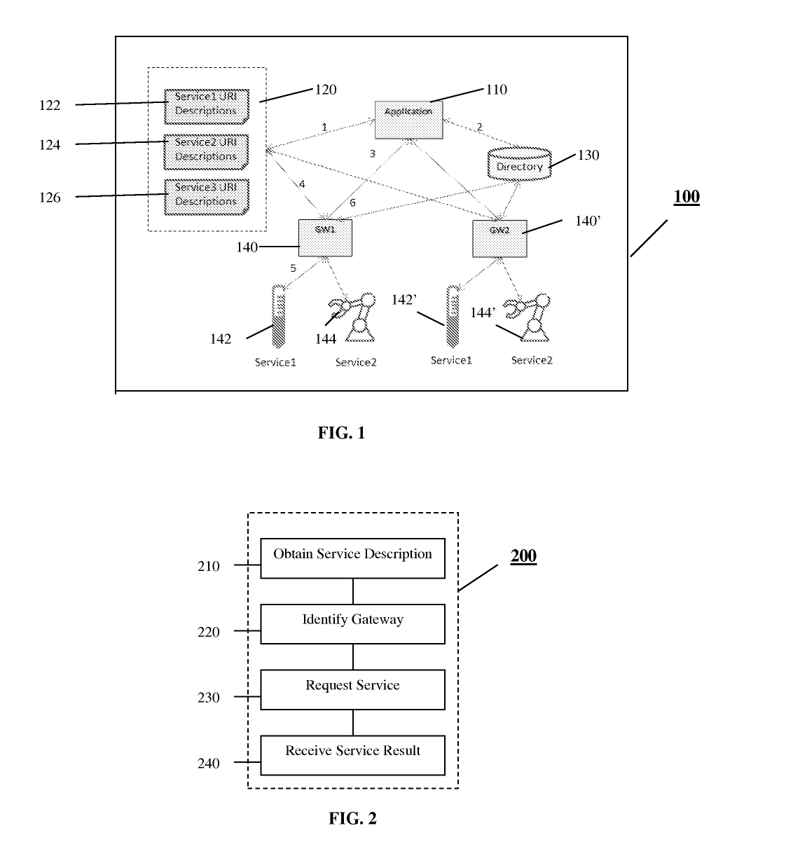

A system 100 for providing a service to an application 110 in accordance with exemplary embodiments is illustrated in FIG. 1. The application 110 may be on user equipment (UE) such as a communication device. The communication device may be a mobile phone, a smartphone, a computer, a computing tablet or a similar device for example.

Each of the components of system 100 (i.e. gateways, directory and server) described below may be located on and, accessible over, a network. The network may be a private or a public network which could include, but is not limited, to a combination of a cellular network, a short range or a long range wireless network or the internet for example.

System 100 may include a plurality of gateways 140, 140′. Each of the gateways 140 and 140′ may have at least a sensor associated therewith. Gateway 140 may be associated with sensor 142 and gateway 140′ may be associated with sensor 142′. Each of gateway 140 and 140′ may also have an actuator associated therewith. Gateway 140 may be associated with actuator 144 and gateway 140′ may be associated with actuator 144′.

The capabilities of sensors and (any) actuators connected to the network via a gateway are known and available to the gateway (i.e. the gateway through which the sensors/actuators are connected). A gateway registers its capabilities with a directory. A gateway specifies the sensors (and actuators) that are connected to it and the computational capability. Gateway 140 may register with directory 130 that sensor 142 and 144 are associated with gateway 140 and the capabilities of sensor 142 and of actuator 144. Similarly, gateway 140′ may register with directory 130 that sensor 142′ and 144′ are associated with gateway 140′ and the capabilities of sensor 142′ and of actuator 144′.

A server 120 in system 100 may have stored therein descriptions for a plurality of services 122, 124 and 126. The service description may specify the sensors/actuators and computational capability required for performing the service. For example, if the service requirement is to monitor a temperature at a sensor location, then the service description may specify the need for a temperature measuring sensor in order to perform the service. The service description may be developed by third parties. Server 120 may also be referred to as service description server 120.

When an application 110 needs the use of a service at a gateway, the description for the service may be looked up at server 120. The service description may specify the gateway capabilities needed for performing the service. This information may be provided to the application.

The application 110 may then communicate with directory 130 to locate or identify a gateway suitable for performing the service—that is, the gateway having the capabilities specified by the service description. Upon identifying a suitable gateway (such as gateway 140 for example), the application (after a service and a gateway have been identified) creates a temporary service unified resource identifier (URI) in the form of, for example, http://[GatewayURI]/services/?uri=[serviceURI]. The temporary service URI may identify the service for the dynamically deployed service. The service URI may be sent to the suitable gateway (that has been identified above) by the application 100.

The application can request a service with the URI and concurrently trigger the service creation. The URI may then be stored at the gateway to be associated with the temporary service so that it is possible for other applications to request the service with the same URI without the need to create another temporary service.

The (identified) gateway, such as gateway 140 for example, may resolve the service URI and may obtain the service description from the service descriptions in server 120. The service may be deployed at the gateway. The service deployment may include obtaining information from the sensor 142 or sending instructions to actuator 144 to perform a task associated with the actuator. The gateway obtains the service description from the URI specified in the request and dynamically deploys the service for each service request.

A service request to a sensor may be for a reading of temperature measured by a temperature sensor for example. This request may be for one reading or a periodic reading with a specified frequency (e.g. every hour or every day at a particular time) for example. A service request to an actuator may be for adjusting a thermostat based on reading from a temperature sensor for example.

A result (or results) from the service may be provided to the gateway which may then submit it (them) to the application requesting the service. Upon the service being performed, the service may be removed from the gateway.

In some embodiments, multiple gateways may be capable of providing the requested service. If, for example, two gateways are capable of providing the service, the application can request a service from either one of the two gateways. The application may transmit a request in the form of http://www.gateway1.com/services/?uri=www.service1.com or in the form of http://www.gateway2.com/services/?uri=www.service1.com depending on whether the application requests service from a first gateway or from a second gateway.

A method in accordance with exemplary embodiments may be described with reference to FIG. 2. A user equipment (UE) may desire a particular service to be performed by one or more sensors in a network of sensors. The service description for the service may be obtained by the application (that is on or available to the UE) from a server at step 210. The service description may include or specify the gateway capabilities needed for performing the service. The service description specification may be provided by the application to a gateway.

The gateway may identify to the application at least one gateway having the required capabilities at step 220. The application may submit the service request to the at least one identified gateway at step 230. The identified gateway may perform the service and provide results to application at step 240. Each gateway may be associated with at least one of a sensor and/or an actuator. Each gateway may provide its capabilities to the gateway.

An exemplary user equipment (UE) 300 is illustrated in FIG. 3. UE 300 may include, inter alia, a receiving means 310, a processor 320, a computer readable medium 330 in the form of memory and a transmitting means 340. The receiving means and the transmitting means may be combined and referred to as a transceiver or a communication interface. The transceiver or the communication interface may include separate receiving and transmitting modules.

An application (such as application 110 of FIG. 1) requesting the service may be stored in memory 330. An identity of the service may also be stored in memory 330. The processor 320 may instruct the transceiver (via transmitter 340 for example) to transmit the service to a network location (such as server 120) and receive (via receiver 320 for example) a description of the service including gateway capabilities needed for performing the service from the network location. The processor 320 may instruct the transceiver to transmit the service description to a directory (such as directory 130) and receive an identity of a gateway having the required capabilities from the directory. The processor 320 may also instruct the transceiver to transmit the service request to the at least one identified gateway (such as gateway 140) and receive results of the service request from the gateway.

The memory may also store the description received from the network location, the identity of a gateway received from the directory and the results received from the gateway. Receiving means 310, processor 320, memory 330, transmitting means 340 and user interface 360 may be interconnected via a bus 350.

In one embodiment, in order for processor 320 to perform the steps illustrated in FIG. 2, memory 330 may comprise a computer program (CP) 335 with computer program modules which when run by the processor 320 causes the user equipment 300 to perform all or some of the steps illustrated in FIG. 2.

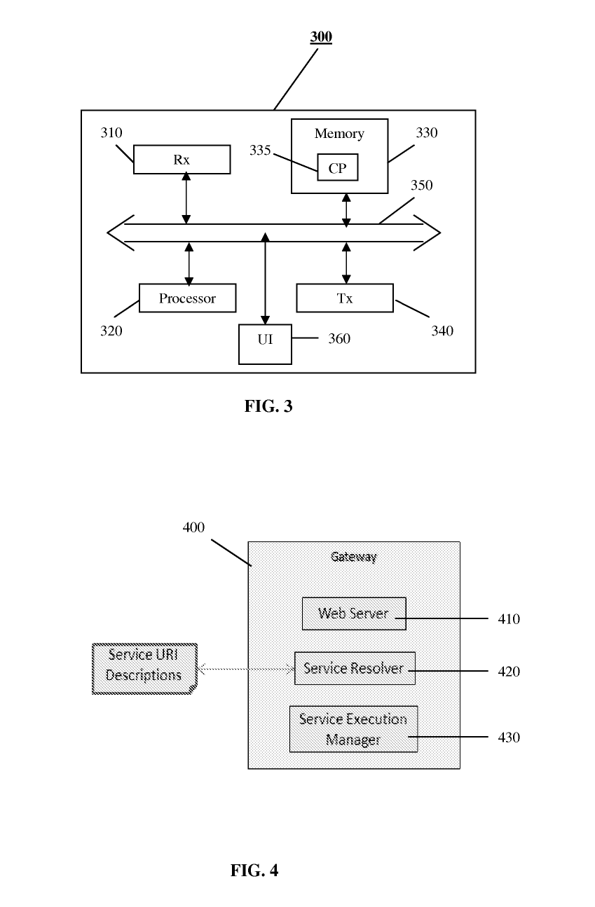

A gateway in accordance with exemplary embodiments is illustrated in FIG. 4. Gateway 400 may include a plurality of functional entities or modules such as web server 410, a service resolver 420 and a service execution manager 430.

Web server 410 may receive a HTTP (hyper text transfer protocol) service request from an application. Service resolver 420 may resolve the service URI and obtain the service description (from server 120 of FIG. 1 for example). Service execution manager 430 may deploy the service locally and execute the service by utilizing sensor(s) and/or actuator(s) associated with the gateway.

The service description can use any currently existing standards. It can be an executable program, java scripts, a WSDL (Web Services Description Language) file or similar standard for example. An exemplary logic for a service (including a plurality of services) may be illustrated as follows:

```
Service 1: Get sensor readings every minute
(http://www.readsensor.com/service1)
While (GetReading=True) {
    Temp=GetValue(TempSensor);
    Wait(60);
}
Service 2: Decrease and Increase temperature
(http://www.performactuation.com/service2)
TempAction=GetCommand;
If (TempAction=IncreaseTemp) {
    Increase(TempActuator);
}
If (TempAction=DecreaseTemp) {
    Decrease(TempActuator);
}
Service 3: Keep temperature between 25° C. and 30° C.
(http://www.climatecontrol.com/service3)
While (TempControl=True) {
    Temp=GetValue(TempSensor);
    If (Temp<25) {
        Increase(TempActuator);
    }
    If (Temp>30) {
        Decrease(TempActuator);
    }
}
```

The logics of the services for these examples do not exist in the gateway prior to the service requests. Service 1 may provide sensor readings; Service 2 may provides temperature adjustment; and Service 3 may provide climate control.

An application may decide on the service that is to be used and may submit the URI of the general service description to the gateway in its service request. The services provided by the gateway are not limited and the user of the application may decide which service or services are to used. The service descriptions can be developed by third parties independent of, or in cooperation with, the gateway providers. By allowing third party service development, the number of services that can be deployed at gateways can be increased.

Gateway 400 may further include (not illustrated in FIG. 4) a processor, a memory and a communication interface (transmitter/receiver or transceiver for example). The communication interface may provide connection with the sensors/actuators and a network. The connection to the network may facilitate communication with the application (within a user equipment for example), the directory, the service description server, etc.

As described above, with reference to FIG. 1, gateway 140 may receive a service request (i.e. service URI) from application 110. The received service URI results from (or following) the application identifying/specifying a desired service, obtaining a service description from the service description server, submitting the service description to the directory to identify a gateway capable of performing the service and generating the service URI.

Referring to FIG. 1, the service descriptions server 120 and the directory 130 can be at one network location or at different locations. The directory describes the capability of gateways and service descriptions server describes how a service can be performed and the inputs required for the performance of the service.

The directory 130 and one of the gateways can be at one network location; however, the directory has be accessible to all gateways. The directory can also be at a network location that is different from the respective network location of all the gateways.

A gateway and its associated sensors and/or actuators need not to be at the same network location. The location relationship may depend on the communication technology that is utilized. If short range communication is utilized, the gateway and its associated sensors/actuators may be located close to each other.

Several advantages may be realized by exemplary embodiments. These include: fast service deployment, new business opportunities for gateway providers and service description providers, user customized service deployment, flexible business models, separated hardware and software development and simple service request interface.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

1. A method of obtaining a service from one of a plurality of gateways, the method comprising the steps of:
obtaining a description for the service including gateway capabilities needed for performing the service;
identifying at least one gateway having the required capabilities from a directory;
submitting the service request to the at least one identified gateway; and
receiving results of the service request from the gateway wherein each gateway is associated with at least one of a sensor and an actuator and the identified gateway provides a functionality of the associated sensor and actuator for performing the service request.

2. The method of claim 1, further comprising:
the gateway obtaining the description for the service.

3. The method of claim 1, further comprising:
the gateway obtaining information from an associated sensor.

4. The method of claim 1, further comprising:
the gateway issuing commands to an associated actuator to actuate an associated sensor to perform a task.

5. The method of claim 1, further comprising:
registering capabilities of the gateway with the directory.

6. The method of claim 5, wherein the capabilities include functionality of the sensors and actuators associated with the gateway.

7. The method of claim 1, wherein the identification provided by the directory is a uniform resource identifier (URI).

8. The method of claim 7, wherein the identified gateway resolves the URI.

9. A user equipment (UE) comprising:
a user interface for user input of a request for execution of a service;
a transceiver for communicating with a plurality of network locations;
a processor for
instructing the transceiver to:
transmit the user requested service to a network location and receive a description of the service including gateway capabilities needed for performing the service from the network location,
transmit the service description to a directory and receive an identity of a gateway having the required capabilities from the directory,
transmit the service request to the at least one identified gateway and receive results of the service request from the gateway wherein each gateway is associated with at least one of a sensor and an actuator and the identified gateway provides a functionality of the associated sensor and actuator for performing the service request; and
a memory for storing:
an identity of the user requested service,
the description received from the network location,
the identity of a gateway received from the directory, and
the results received from the gateway.

10. The user equipment of claim 9 wherein the processor is further for instructing the identified gateway to actuate at least one sensor associated with the gateway to obtain the results.

11. The user equipment of claim 9 wherein the transceiver is further for receiving identities of a plurality of gateways having the required capabilities and the processor is for selecting one of the received plurality of identities.

12. The user equipment of claim 9 wherein the transceiver is further for communicating via at least one of a short range, a wireless, a wired and a cellular communication interface.

13. The user equipment of claim 9 wherein the user interface is further for providing results of the requested service to the user.

14. A system for providing a service to a user of a communication device comprising:
a server at a network location having a plurality of service descriptions stored therein;
a plurality of gateways on the network each having associated with at least one of a sensor and an actuator; and
a directory on the network and connected to the gateways and including information about each of the gateways wherein the communication device specifies a service and a description for the specified service is retrieved from the server and provided to the directory for identifying a gateway for performing the service wherein the identified gateway provides a functionality of the associated sensor and actuator for performing the service request.

15. The system of claim 14, wherein the communication device is one of a smartphone, a tablet computing device, a personal computing device and a desktop computer

16. The system of claim 14, wherein the description for the service includes gateway capabilities needed for performing the service.

17. The system of claim 14, wherein the directory compares the needed capabilities with information stored in the directory from each of the gateways connected to the directory to identify at least one suitable gateway and provides the gateway identity to the communication device.

18. The system of claim 17, wherein the communication device communicates the service description to the identified gateway.

19. The system of claim 14, wherein the identified gateway performs the service utilizing at least one of a sensor and an actuator associated with the gateway.

20. The system of claim 19, wherein the gateway provides the service to the communication device.

21. The system of claim 14, wherein the sensors are environmental sensors.

22. The system of claim 21, wherein the actuators are for controlling an environmental controller based on readings from the sensors in accordance with the service request.

23. A non-statutory computer readable memory medium storing instructions that, when executed, cause a user equipment to implement a method of obtaining a service from one of a plurality of gateways, the method comprising:
obtaining a description for the service including gateway capabilities needed for performing the service;
identifying at least one gateway having the required capabilities from a directory;
submitting the service request to the at least one identified gateway; and
receiving results of the service request from the gateway wherein each gateway is associated with at least one of a sensor and an actuator and the identified gateway provides a functionality of the associated sensor and actuator for performing the service request.
